(19) United States
(12) Patent Application Publication
(10) Pub. No.: US 2012/0146890 A1
(43) Pub. Date: Jun. 14, 2012

(54) HAPTIC ROCKER BUTTON FOR VISUALLY IMPAIRED OPERATORS

(75) Inventor: Christopher K. Karstens, Apex, NC (US)

(73) Assignee: International Business Machines Corporation, Armonk, NY (US)

(21) Appl. No.: 12/963,062

(22) Filed: Dec. 8, 2010

(51) Int. Cl. G09G 5/00

(52) U.S. Cl. 345/156

(57) ABSTRACT

In some embodiments, a device includes a converter, a haptic rocker button, a sensor, and a controller. In some embodiments, a method include receiving data in a mobile device, converting the data into Braille content, presenting the Braille content on a haptic rocker button, and controlling a horizontal movement of the Braille content on the haptic rocker button.

### BACKGROUND

Embodiments of the inventive subject matter generally relate to the field of data displays for the blind and visually impaired, and, more particularly, to haptic technology for displaying Braille on mobile devices.

Mobile devices such as cell phones, smart phones, and PDAs generally present data in a text format. The text format can be text messages, web pages, and emails. Users of mobile devices generally read text vertically and horizontally, and users can generally scroll vertically and horizontally through the text as needed. Mobile devices can have no display or input capabilities for the blind or visually impaired, and when such capabilities are included in mobile devices, these capabilities are very limited for visually impaired or blind operators.

Haptic displays are bendable/formable/malleable surfaces that can be shaped by mechanicals, air pressure, and/or magnetic liquids. Thus, shapes, buttons, letters, numbers, and the like can be displayed in haptic text.

### SUMMARY

Embodiments of the inventive subject matter include a method for converting text to Braille content and presenting the Braille content on a haptic rocker button. In some embodiments, the method includes receiving data in a mobile device, converting the data to Braille content, displaying at least a portion of the Braille content with a haptic rocker button, and controlling a horizontal movement of the displayed Braille content in the haptic rocker button.

### BRIEF DESCRIPTION OF THE DRAWINGS

The present embodiments may be better understood, and numerous objects, features, and advantages made apparent to those skilled in the art by referencing the accompanying drawings.

FIG. 1 depicts a plan view of a mobile phone utilizing a haptic rocker button according to an embodiment of the invention.

FIG. 2 depicts an end view of a mobile phone utilizing a haptic rocker button in a neutral position.

FIG. 3 depicts an end view of a mobile phone utilizing a haptic rocker button with a hand contacting a left side of the haptic rocker button.

FIG. 4 depicts a block diagram of an embodiment of a device in accordance with the invention.

FIG. 5 depicts a flow diagram of an embodiment of the method.

FIG. 6 depicts a flow diagram of a method for the step of controlling a horizontal movement of the Braille content displayed in a haptic rocker button.

FIG. 7 depicts a flow diagram of another method for the step of controlling a horizontal movement of the Braille content displayed in a haptic rocker button.

FIG. 8 depicts a schematic diagram of a computer system in an embodiment of the invention.

### DESCRIPTION OF EMBODIMENT(S)

The description that follows includes exemplary devices, methods, memory, systems, techniques, instruction sequences and computer program products that embody techniques of the present inventive subject matter. However, it should be understood that the described embodiments may be practiced without these specific details. Well-known instruction instances, protocols, structures and techniques have not been shown in detail in order not to obfuscate the description.

The inventive subject matter includes devices, methods, memory, and systems utilizing haptic technology. The haptic technology can be used in conjunction with mobile devices, such as but not limited to mobile phones. The haptic technology allows visually impaired or blind individuals to interpret data normally found in mobile devices by haptically communicating the data in Braille patterns. A haptic rocker button displays the Braille patterns to visually impaired or blind individuals, and the haptic rocker button allows said individuals to control horizontal movement of the Braille displayed in the haptic rocker button.

Embodiments of the method are shown in the figures and discussed below, and it should be understood the operations as presented are exemplary and some operations may be substituted, added, rearranged or removed while still encompassing inventive subject matter. Moreover, it should be understood the order of operations is not to be limited unless explicitly specified herein.

As will be appreciated by one skilled in the art, aspects of the present inventive subject matter may be embodied as a system, method or computer program product. Accordingly, aspects of the present inventive subject matter may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present inventive subject matter may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present inventive subject matter may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present inventive subject matter are described with reference to flowchart illustrations and/or block diagrams of methods, apparatus (systems) and computer program products according to embodiments of the inventive subject matter. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

### Device

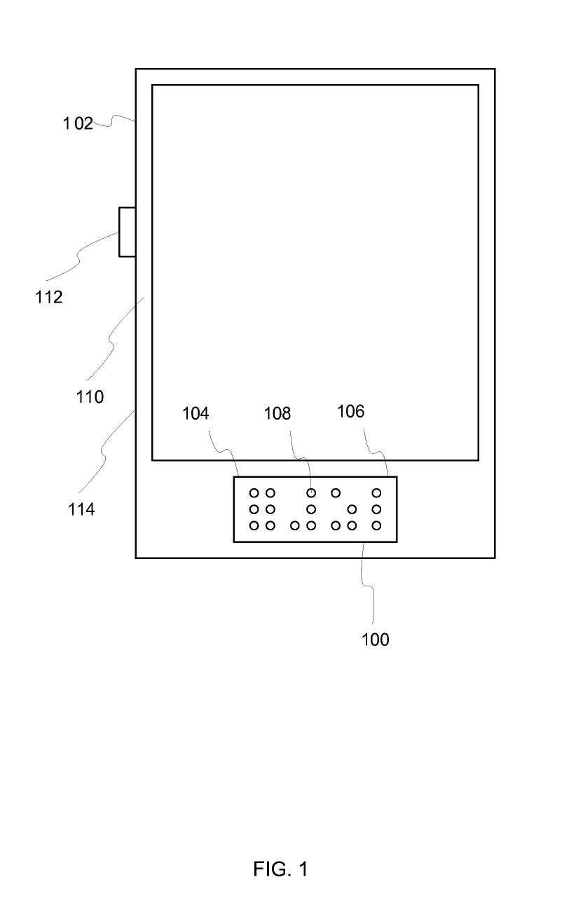

FIG. 1 is a plan view depicting a mobile phone 102 including a haptic rocker button 100, according to an embodiment of the invention. The haptic rocker button 100 displays Braille content 108. The haptic rocker button 100 has a left side 104 and a right side 106, and the haptic rocker button 100 is located on the top surface 110 of the mobile phone 102 adjacent the bottom of the mobile phone 102. A non-haptic input device 112 can be positioned on the side 114 of the mobile phone 102. It should be appreciated the haptic rocker button 100 allows for both input of scrolling control and output for haptic display of Braille content 108.

An individual using the mobile phone 102 can hold the mobile phone 102 in his/her left hand and can use his/her right hand for the haptic rocker button 100. Readers of Braille commonly use the index fingers of both the right hand and the left to read Braille content. The index finger of the left hand commonly functions to determine a vertical position in the Braille content, and the index finger of the right hand commonly functions to determine a horizontal position in the Braille content. Because the haptic rocker button 100 has only horizontal movement of Braille content 108, only one hand (most likely the right hand) is needed to read the Braille content 108. Thus, the left hand of a user of the mobile phone 102 can be used to hold the phone or to scroll vertically through the data of the phone with the non-haptic input device 112, so as to display additional Braille content (e.g., a paragraph above or below the original Braille content 108 shown in the haptic rocker button 100). The left hand can vertically scroll additional Braille content using traditional devices and methods, such as a track ball, touching/sliding a finger against a touch-screen device, the rocker 112 shown in FIG. 1, etc.

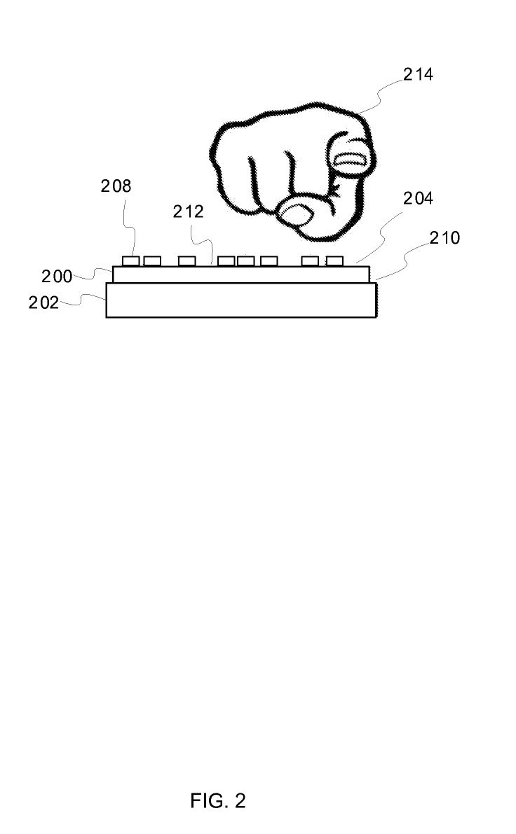

FIG. 2 depicts an end view of a mobile phone 202 including a haptic rocker button 200 in a neutral position. In the neutral position, the Braille content 208 in the haptic rocker button 200 does not scroll in any horizontal direction, i.e. rightward or leftward. Moreover, in the neutral position the sides 204 and 206 of the haptic rocker button 200 are an equal height from the top surface 210 of the mobile phone 202.

The Braille content 208 is shown on the surface 212 of the haptic rocker button 200. The surface 212 is the top surface of the button 200. The Braille content 208 is a Braille-patterned haptic-tactile feedback generated on the surface 212 of the haptic rocker button 200. The haptic-tactile feedback can be forces, vibrations, motions, or the like. The haptic rocker button 200 haptically displays the Braille content 208. The haptic rocker button 200 can be seen on the top surface 210 of the mobile phone 202. A hand 214 of an individual using the mobile phone 202 is placed above the left side 204 of the haptic rocker button 200, and in particular, the right hand 214 is placed above the mobile phone 202 to prepare to use the haptic rocker button 200. The index finger of the right hand 214 is prepared to read Braille content 208 displayed in the haptic rocker button 200.

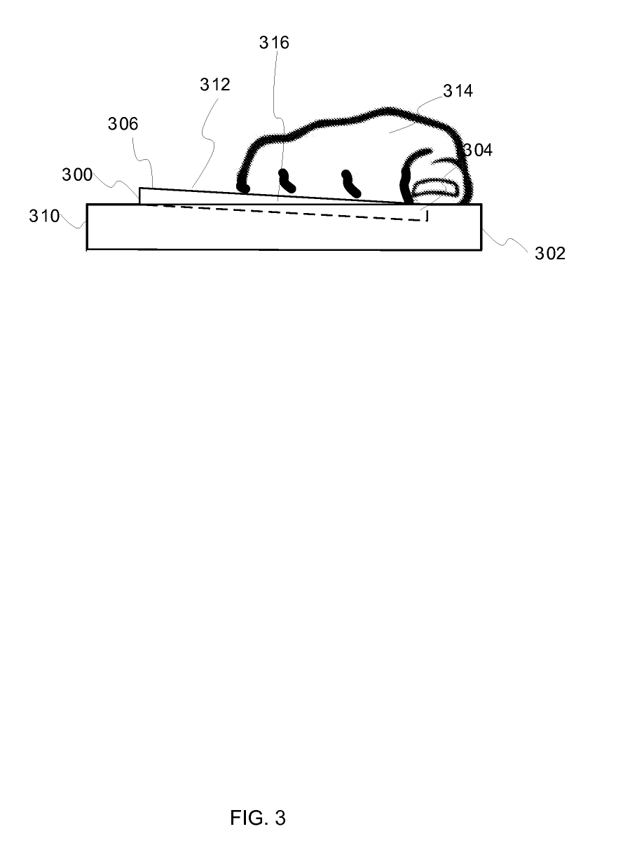

FIG. 3 depicts an end view of a mobile phone 302 including a haptic rocker button 300, with a hand 314 contacting a left side 304 of the haptic rocker button 300. The haptic rocker button 300 haptically displays Braille content on the top surface 312. When the hand 314 contacts the left side 304 of the haptic rocker button 300, the Braille content scrolls leftward. Moreover, when the hand 314 contacts the left side 304 of the haptic rocker button 300, the haptic rocker button 300 pivots, or rocks, about point 316. The hand 314 is a right hand of an individual using the mobile phone 302, and the index finger of the right hand 314 has contacted the left side 304 of the haptic rocker button 300, so that the Braille content in the haptic rocker button 300 scrolls leftward.

When scrolling Braille content leftward, the left side 304 of the haptic rocker button 300 has a height relative to the top surface 310 less than a height of the right side 306 of the haptic rocker button 300 relative to the top surface 310 of the mobile phone 302. The index finger of the hand 314 can contact the right side 306 of the haptic rocker button 300 in a similar manner to scroll the Braille content rightward. Particularly, when the Braille content scrolls rightward, the right side 306 of the haptic rocker button 300 has a height relative to the top surface 310 less than a height of the left side 304 of the haptic rocker button 300 relative to the top surface 310 of the mobile phone 302.

When scrolling leftward, the Braille content can appear to move from the right side 306 of the haptic rocker button 300 to the left side 304 of the haptic rocker button 300. Likewise, when scrolling rightward, the Braille content can appear to move from the left side 304 of the haptic rocker button 300 to the right side 306 of the haptic rocker button 300.

### System Architecture

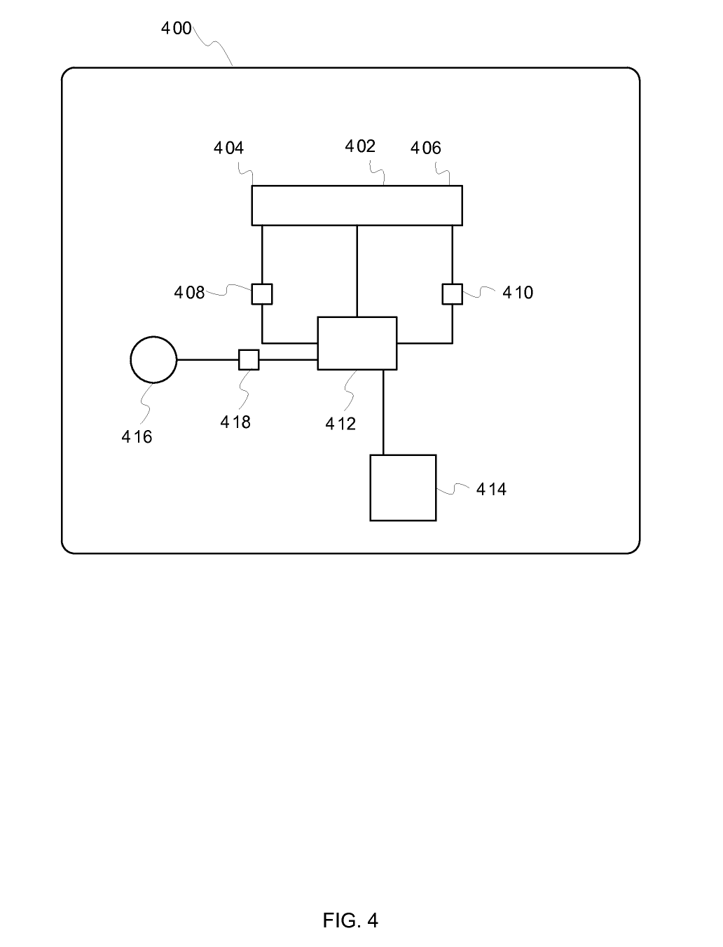

FIG. 4 depicts a block diagram of an embodiment of a device 400 in accordance with the inventive subject matter. The device 400 can have a haptic rocker button 402, sensors 408 and 410, and controller 412. The left side 404 of the haptic rocker button 402 can be connected to sensor 408, and the right side 406 of the haptic rocker button 402 can be connected to sensor 410. The sensors 408 and 410 can be connected to the controller 412, and the controller 412 can be connected to the haptic rocker button 402. The controller 412 generally can receive signals from sensors 408 and 410. The controller 412 can control the Braille content displayed in the haptic rocker button 402.

The controller 412 can also connect to a converter 414, and the converter is a data-to-Braille converter. The converter 414 can have a processor, a processor in combination with a memory device, or solely a memory device adapted to communicate with a processor(s) externally located from the converter 414. The converter 414 can be integrally formed with the controller 412 or can be separately formed form the controller 412. Moreover, the converter 414, although shown as hardware in FIG. 4, can be embodied as software on a processor that can communicate with the various components shown in FIG. 4.

The device 400 can also have a non-haptic input device 416. For example, the non-haptic input device 416 of the device 400 can be a knob positioned on the side of the device 400, so that it can be easily controlled by a user's left hand thumb or finger. A sensor 418 can be connected to the non-haptic input device 416, and the sensor 418 can also be connected to the controller 412.

Sensors 408, 410, and 418 are shown in FIG. 4; however, the device 400 can have any number and arrangement of sensors different than what is shown in FIG. 4. For example, the non-haptic input device 416 can send signals to the controller 412 without use of a sensor 418.

In FIG. 4, the converter 414 can convert data in the device 400 to Braille content. The controller 412 can communicate with the converter 414 to receive Braille content associated with certain data chosen by the user of the device 400. The controller 412 can haptically display the Braille content on a surface of the haptic rocker button 402. Particularly, the controller 412 can generate a Braille-patterned haptic-tactile feedback of the Braille content, and the Braille-patterned haptic-tactile feedback can be displayed on a surface of the haptic rocker button 402.

Sensor 408 can sense an input from the left side 404 of the haptic rocker button 402, and sensor 410 can sense an input from the right side 406 of the haptic rocker button 402. The input from the right side 406 or left side 404 of the haptic rocker button 402 can be the contact of the right side 406 or left side 404 of the haptic rocker button 402 by an index finger of a user of the device 400. When contacted, sensor 408 can send a signal to the controller 412, and the signal can be received in the controller 412. Likewise, sensor 410 can send a signal to the controller 412 when contacted, and the signal can be received in the controller 412. When the controller 412 receives a signal from the sensor 410, the controller 412 can determine a speed of horizontal movement, i.e. rightward scrolling, according to a value of the received signal. When the controller 412 receives a signal from the sensor 408, the controller 412 can determine a speed of horizontal movement, i.e. leftward scrolling, according to a value of the received signal. When no signal is received by the controller 412 from either of sensors 408 or 410, rightward and leftward scrolling can stop, and Braille content can be displayed in the haptic rocker button 402 in a stationary manner. Thus, the controller 412 can control a scroll of the Braille content at the determined speed. The controller 412 can receive another signal from the sensor, and the controller 412 can then determine another speed according to a value of the other signal. The controller 412 then can compare the speed with the other speed in order to control the speed of the scroll of the Braille content according to the compared speeds.

A non-haptic input device 416 can vertically scroll through data in the device 400, which is converted to Braille content and displayed as Braille content in the haptic rocker button 402. Thus, the non-haptic input device 416 can vertically scroll through the Braille content. The non-haptic input device 416 can connect to a sensor 418, and the sensor 418 can connect to the controller 412. When contacted by the user, the sensor 418 can sense an input from the non-haptic input device 416. The sensor 418 can send a signal to the controller 412, and the controller 412 receives the signal. The controller 412 can communicate with the converter 414 to receive Braille content of a additional data vertically above or below the data currently displayed as Braille content in the haptic rocker button 402, or the controller 412 can have additional Braille content that is vertically above or below the currently displayed Braille content ready to display in the haptic rocker button 402. The controller 412 can then haptically display the additional Braille content that is vertically different from the original Braille content in the haptic rocker button 402 or on the surface of the haptic rocker button 402.

The controller 412 can store an amount of Braille content therein and can retrieve additional Braille content to display the additional Braille content in the haptic rocker button 402 if a user contacts the right side 404 or left side 404 of the haptic rocker button 402 or if a user contacts the non-haptic input device 416. If the controller 412 does not have additional Braille content ready for display in the haptic rocker button 402, the controller 412 can communicate with the converter 414 to receive additional Braille content. If the non-haptic input device 416 is contacted, the controller 412 can control the haptic rocker button 402 to display additional Braille content vertically above or below the original Braille content. If either of the sides 404 or 406 of the haptic rocker button 402 is contacted, the controller 412 can control the haptic rocker button 402 to display additional Braille content horizontally rightward or leftward of the original Braille content.

### Operations

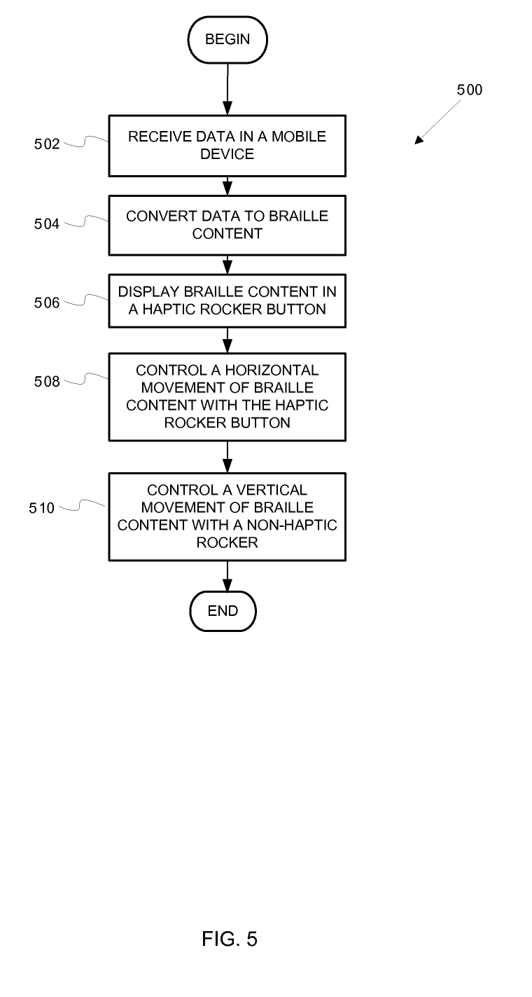

FIG. 5 depicts a flow diagram of an embodiment of the method 500. The method 500 commences at block 502. At block 502, data is received in a mobile device. The data can be a text message, an email, a web page, streamed content, or the like. Flow then proceeds to block 504.

At block 504, data is converted to Braille content. The conversion typically includes receiving text data of the mobile device and processing the data into a Braille format for display in the haptic rocker button. Certain data can be chosen by the user of a device (such as an email or text message), and the data can be converted into Braille content. The flow then proceeds to block 506.

At block 506, the haptic rocker button displays the Braille content. The Braille content can be Braille text displayed in the patterns unique for Braille. The Braille content is haptically displayed. To haptically display Braille content, a Braille-patterned is generated on a surface of the haptic rocker button. Additionally, the haptic rocker button can present haptic-tactile feedback, such as a force, vibration, motion, etc. The haptic-tactile feedback can be transmitted from the haptic rocker button to the user and can be interpreted as a Braille-patterned sensation by the user. A user can touch the haptic rocker button and feel the sensation with an index finger of a right hand. The flow then proceeds to block 508.

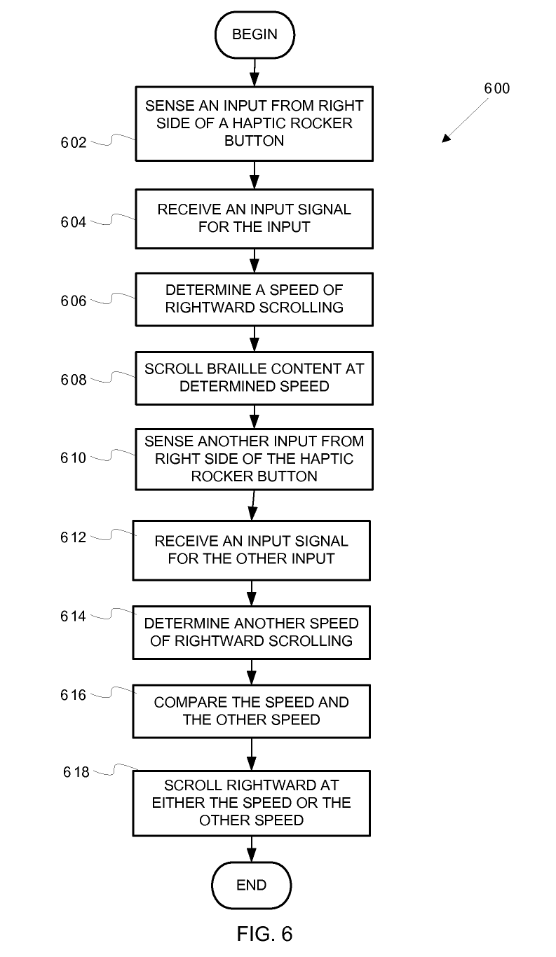

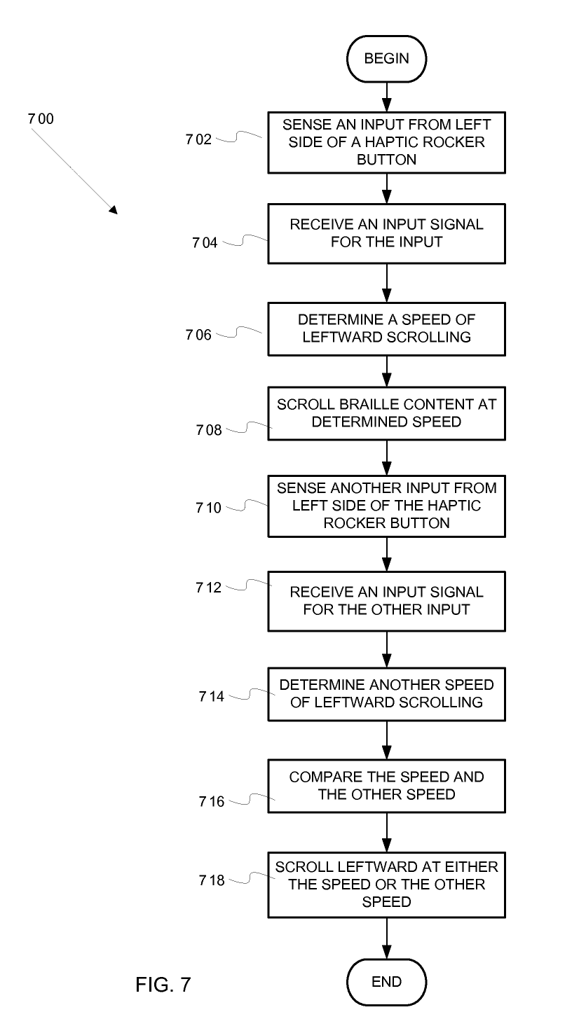

At block 508, a horizontal movement of Braille content is controlled with the haptic rocker button. Horizontal movement can be differentiated between rightward movement of the Braille content and leftward movement of the Braille content. More details regarding the control of horizontal movement of the Braille content are discussed in FIGS. 6 and 7 below. The flow then proceeds to block 510.

At block 510, a vertical movement of Braille content is controlled with a non-haptic input device. The non-haptic input device can be a joystick, lever, track ball, or the like, and the non-haptic input device can be actuated generally by changing a position of the non-haptic input device. If a position of the non-haptic input device is changed, the additional Braille content is displayed in the haptic rocker button. The method 500 terminates after block 510; however, the embodiment of the method 500 shown in FIG. 5 can repeat indefinitely, and the operations of blocks 502-510 can loop any number of times before the method 500 terminates.

FIG. 6 depicts a flow diagram of a method 600 for controlling a horizontal movement of the Braille content displayed in a haptic rocker button. In some embodiments, the flow 600 further describes block 508 of FIG. 5. Particularly, the controlled horizontal movement is a rightward scroll. The method 600 commences at block 602. At block 602 a sensor senses an input from the haptic rocker button. The input can be that the right side of the haptic rocker button has been rocked or pivoted downward toward the top surface of the device. The sensor can sense various intensity levels of the input. The flow proceeds to block 604.

At block 604, a controller receives a signal sent from the sensor in response to the sensed input. The signal can be electric, pneumatic, thermal, etc. The signal has a value, and the value can vary according to the intensity of the input. The flow proceeds to block 606.

At block 606, a speed of rightward scrolling the Braille content is determined according to the value of the signal. For example, if a user contacts the right side of the haptic rocker button with a large pressure, the input can be larger and the value of the signal can correspondingly be larger. A faster speed of rightward scrolling can be determined from the larger signal. Further, a slower speed of scrolling can be determined from a smaller signal. These determinations can be reversed so that a large pressure determines a slower speed of rightward scrolling. Also, if the sensor senses no input from the right side of the haptic rocker button, the speed of rightward scrolling is zero. The flow proceeds to block 608.

At block 608, the Braille content is scrolled rightward at the determined speed. Braille content in the form of Braille-patterned haptic-tactile feedback can be smoothly moved under the fingers of a user of the haptic rocker button as the Braille content is scrolled rightward. The flow proceeds to block 610.

At block 610, another input in sensed from right side of the haptic rocker button. The other input can be that the right side of the haptic rocker button has been rocked or pivoted downward toward the top surface of the device. The sensor can sense various intensity levels of the other input. The flow proceeds to block 612.

At block 612, the controller receives another signal sent from the sensor in response to the sensed other input. The other signal can be electric, pneumatic, thermal, etc. The other signal has a value, and the value can vary according to the intensity of the other input. The flow proceeds to block 614.

At block 614, another speed of rightward scrolling of the Braille content is determined according to the value of the other input. The other speed is determined according to the value of the other signal. For example, if a user contacts the right side of the haptic rocker button with a large pressure, the other input can be larger and the value of the other signal can correspondingly be larger. A faster speed of rightward scrolling can be determined from the larger signal. Further, a slower speed of scrolling can be determined from a smaller signal. These determinations can be reversed so that a large pressure determines a slower speed of rightward scrolling. Also, if the sensor senses no input from the right side of the haptic rocker button, the other speed of rightward scrolling is zero. The flow proceeds to block 614.

At block 616, the speed of rightward scrolling determined by the value of the signal is compared with the other speed of rightward scrolling determined by the value of the other signal. The speed of rightward scrolling can be less than, equal to, or greater than the other speed of rightward scrolling. The flow proceeds to block 618.

At block 618, Braille content is scrolled rightward at either the speed or the other speed. If the speed is equal to the other speed, the Braille content continues to scroll rightward at the speed. If the speeds are unequal (i.e. the speed is greater than or less than the other speed) the Braille content is scrolled rightward at the other speed. Operations in blocks 602-618 in FIG. 6 can repeat and can be performed in various orders not explicitly described in the embodiment shown in FIG. 6.

FIG. 7 depicts a flow diagram of a method 700 for controlling a horizontal movement of the Braille content displayed in a haptic rocker button. In some embodiments, the method 700 further describes the operation at block 508 of FIG. 5. Particularly, the controlled horizontal movement is a leftward scroll. The method 700 commences at block 702. At block 702 a sensor senses an input from the haptic rocker button. The input can be that the left side of the haptic rocker button has been rocked or pivoted downward toward the top surface of the device. The sensor can sense various intensity levels of the input. The flow proceeds to block 704.

At block 704, a controller receives a signal sent from the sensor in response to the sensed input. The signal can be electric, pneumatic, thermal, or the like. The signal has a value, and the value can vary according to the intensity of the input. The flow proceeds to block 706.

At block 706, a speed of leftward scrolling the Braille content is determined according to the value of the signal. For example, if a user contacts the left side of the haptic rocker button with a large pressure, the input can be larger and the value of the signal can correspondingly be larger. A faster speed of leftward scrolling can be determined from the larger signal. Further, a slower speed of scrolling can be determined from a smaller signal. These determinations can be reversed so that a large pressure determines a slower speed of leftward scrolling. Also, if the sensor senses no input from the left side of the haptic rocker button, the speed of leftward scrolling is zero. The flow proceeds to block 708.

At block 708, the Braille content is scrolled leftward at the determined speed. Braille content in the form of Braille-patterned haptic-tactile feedback can be smoothly moved under the fingers of a user of the haptic rocker button as the Braille content is scrolled leftward. The flow proceeds to block 710.

At block 710, another input in sensed from left side of the haptic rocker button. The other input can be that the left side of the haptic rocker button has been rocked or pivoted downward toward the top surface of the device. The sensor can sense various intensity levels of the other input. The flow proceeds to block 712.

At block 712, the controller receives another signal sent from the sensor in response to the sensed other input. The other signal can be electric, pneumatic, thermal, etc. The other signal has a value, and the value can vary according to the intensity of the other input. The flow proceeds to block 714.

At block 714, another speed of leftward scrolling of the Braille content is determined according to the value of the other input. The other speed is determined according to the value of the other signal. For example, if a user contacts the left side of the haptic rocker button with a large pressure, the other input can be larger and the value of the other signal can correspondingly be larger. A faster speed of leftward scrolling can be determined from the larger signal. Further, a slower speed of scrolling can be determined from a smaller signal. These determinations can be reversed so that a large pressure determines a slower speed of leftward scrolling. Also, if the sensor senses no input from the left side of the haptic rocker button, the other speed of leftward scrolling is zero. The flow proceeds to block 714.

At block 716, the speed of leftward scrolling determined by the value of the signal is compared with the other speed of leftward scrolling determined by the value of the other signal. The speed of leftward scrolling can be less than, equal to, or greater than the other speed of leftward scrolling. The flow proceeds to block 718.

At block 718, Braille content is scrolled leftward at either the speed or the other speed. If the speed is equal to the other speed, the Braille content continues to scroll leftward at the speed. If the speed is unequal (i.e. the speed is greater than or less than the other speed) the Braille content is scrolled leftward at the other speed. Operations in blocks 702-718 in FIG. 7 can repeat and can be performed in various orders not explicitly described in the embodiment shown in FIG. 7.

### Hardware and Operating Environment

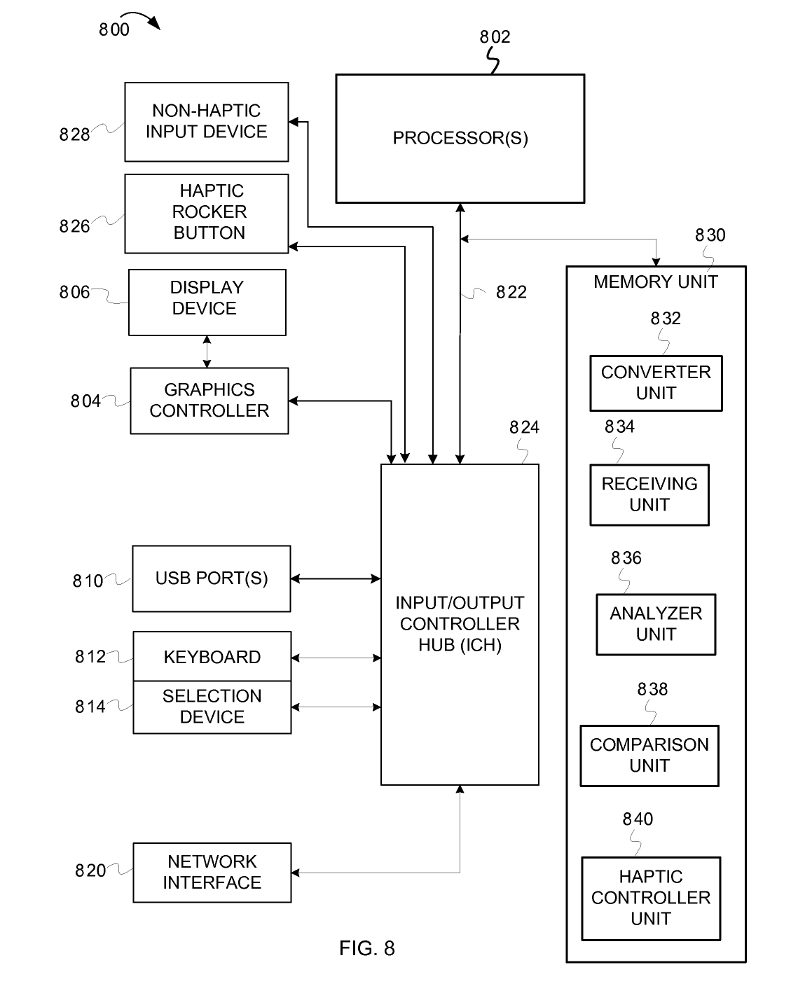

FIG. 8 depicts a schematic diagram of a computer system in an embodiment of the invention. The computer system 800 includes a processor(s) 802. The processor(s) 802 may include multiple processors, multiple cores, multiple nodes, and/or implementing multi-threading, etc. The computer system 800 also includes a memory unit 830, processor bus 822, and Input/Output Controller Hub (ICH) 824. The processor(s) 802, memory unit 830, and ICH 824 are coupled to the processor bus 822.

The ICH 824 provides an interface to I/O devices or peripheral components for the computer system 800. The ICH 824 may comprise any suitable interface controller to provide for any suitable communication link to the processor(s) 802, memory unit 830 and/or to any suitable device or component in communication with the ICH 824. For one embodiment of the invention, the ICH 824 provides suitable arbitration and buffering for each interface.

For one embodiment of the invention, the ICH 824 provides an interface to one or more suitable universal serial bus (USB) devices through one or more USB ports 810. For one embodiment, the ICH 824 also provides an interface to a keyboard 812, a selection device such as a button 814. For one embodiment of the invention, the ICH 824 also provides a network interface 820 though which the computer system 800 may communicate with other computers and/or devices. The ICH 822 also provides an interface to a graphics controller 804 that controls the display of information on a display device 806.

A haptic rocker button 826 is connected to the ICH and interconnected to the memory unit 830. A non-haptic input device 828 is connected to the ICH and interconnected to the member 830. The memory unit 830 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more realizations of machine-readable media. The processor bus 822 may be PCI, ISA, PCI-Express, HyperTransport®, InfiniBand®, NuBus, etc. A network interface 820 (e.g., an Ethernet interface, a Frame Relay interface, SONET interface, wireless interface, etc.), and a storage device(s) (e.g., optical storage, magnetic storage, etc.).

The memory unit 830 may include a converter unit 832, a receiving unit 834, an analyzer unit 836, a comparison unit 838, and a haptic controller unit 840. The converter unit 832 may convert data of a device into Braille content. The haptic controller unit 840 may haptically display the Braille content on a surface of a haptic rocker button. Particularly, the haptic controller unit 840 may generate a Braille-patterned haptic-tactile feedback on the surface of the haptic rocker button, where the Braille content is the Braille-patterned haptic-tactile feedback. The receiving unit 834 may receive a signal from a sensor. The analyzer unit 836 may determine a speed of a horizontal movement, and the haptic controller unit 840 may scroll the Braille content at the determined speed. The receiving unit 834 may receive another signal from the sensor, and the analyzer unit 836 may determine another speed of the horizontal movement. The comparison unit 838 may compare the speed of the horizontal movement with the other speed of the horizontal movement, and the haptic controller unit 840 may scroll the Braille content at the determined other speed.

The memory unit 830 embodies functionality to implement embodiments described above. The memory unit 830 may include one or more functionalities that facilitate the haptic display of Braille patterns on a haptic rocker button, where the haptic rocker button is also used to control a horizontal movement, and more particularly, a rightward or leftward speed of scrolling of the Braille patterns across the haptic rocker button.

Some or all of the functionality of the haptic rocker button may be implemented with program code embodied in the memory unit 830 and/or processor 802, any co-processors, other cards, etc. Any one of these functionalities may be partially (or entirely) implemented in hardware and/or on the processing unit 802. For example, the functionality may be implemented with an application specific integrated circuit, in logic implemented in the processing unit 801, in a co-processor on a peripheral device or card, etc. Further, realizations may include fewer or additional components not illustrated in FIG. 8 (e.g., video cards, audio cards, additional network interfaces, peripheral devices, etc.).

The processor unit 802, and the network interface 820 are coupled to the ICH 824. Although illustrated as being coupled to the ICH 824, the memory unit 830 may be coupled to the processor unit 802.

While the embodiments are described with reference to various implementations and exploitations, it will be understood that these embodiments are illustrative and that the scope of the inventive subject matter is not limited to them. In general, techniques for the haptic display of Braille patterns on a haptic rocker button, where the haptic rocker button is also used to control a horizontal movement, and more particularly, a rightward or leftward speed of scrolling of the Braille patterns across the haptic rocker button, as described herein may be implemented with facilities consistent with any hardware system or hardware systems.

Many variations, modifications, additions, and improvements are possible. For example, the haptic rocker button 300 can alternatively embody a haptic pointing stick, which in contrast to the button 300 shown in FIG. 3 (which has a length much greater than a height), has a length more approximate to a height thereof. Like the haptic rocker button 300, the haptic pointing stick has a right side, a left side, and a surface. The surface is a top surface. The pointing stick can have a neutral center position, and an operator can contact the left or right side so as to push the stick left or right about a point at different pressures corresponding to different speeds of scrolling Braille text. When an operator of the haptic pointing stick lets go of the pointing stick, the haptic pointing stick can return to the neutral center position.

The haptic display is located on the top surface of the haptic pointing stick. The top surface of the haptic pointing stick can have a diameter (if circular in shape) or width (if another shape) of an appropriate size for reading scrolled Braille text. Because Braille is read in cells of six raised dots per cell, the diameter must be large enough to accommodate at least one Braille symbol so that most human-Braille readers can interpret the symbol on the haptic display of the haptic pointing stick. For example, the diameter of a circular haptic pointing stick can be approximately between 1.5 mm and 3 mm.

The haptic pointing stick can have restricted left and right movement only, or can have unrestricted directions of movement. The movement restriction can be manually or electronically enabled or disabled. For example, a restriction on/off button can be manually switched by an operator. In another example, upon putting the device into Braille-reading mode, the software of the device can automatically control an electronic restriction switch to limit the motion of the haptic pointing stick.

To operate the haptic pointing stick, instead of lifting a finger from the right side of the button and then pushing the finger down on the left side of the button to change direction, an operator of the haptic pointing stick embodiment of the haptic rocker button can push the haptic pointing stick to the left or to the right. No finger repositioning is necessary for the haptic pointing stick, and an operator's finger always remains at a top surface of the haptic pointing stick even when changing scrolling directions.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A method comprising:
receiving data in a mobile device;
converting the data into a Braille content;
presenting at least a portion of the Braille content on a haptic rocker button; and
controlling a horizontal movement of the Braille content displayed in the haptic rocker button.

2. The method of claim 1, the presenting further comprising:
generating a Braille-pattern on a surface of the haptic rocker button, wherein the Braille pattern corresponds to the Braille content.

3. The method of claim 1, further comprising:
controlling a vertical movement of the displayed Braille content with a non-haptic input device.

4. The method of claim 1, wherein the controlling the horizontal movement of the Braille content displayed in a haptic rocker button includes:
sensing a first input from the right side of the haptic rocker button;
receiving a first signal based on the first input;
determining a first speed of rightward scrolling according to a value associated with the signal; and
scrolling the Braille content to the right in the haptic rocker button at the first speed.

5. The method of claim 4, wherein the controlling the horizontal movement of the Braille content displayed in a haptic rocker button further includes:
sensing a second input from the right side of the haptic rocker button;
receiving a second signal for the first input;
determining a second speed of rightward scrolling according to a second value associated the second signal;
comparing the first speed and the second speed; and
scrolling the content to the right in the haptic rocker button at the second speed.

6. The method of claim 1, wherein the controlling a horizontal movement of the Braille content displayed in a haptic rocker button comprising:
sensing a first input from the left side of the haptic rocker button;
receiving a first signal for the first input;
determining a first speed of leftward scrolling according to a first value associated with the first signal; and
scrolling the content to the left in the haptic rocker button at the first speed.

7. The method of claim 6, wherein the controlling the horizontal movement of the Braille content displayed in a haptic rocker button further includes:
sensing a second input from the left side of the haptic rocker button;
receiving a second signal for the first input;
determining a second speed of leftward scrolling according to a second value associated the second signal;
comparing the first speed and the second speed; and
scrolling the content to the left in the haptic rocker button at the second speed.

8. One or more computer readable storage media having stored therein a program product, which when executed on a set of one or more processor units causes the set of one or more processor units to perform operations comprising:
selecting text in a mobile device;
converting the text into a Braille content; and
presenting the Braille content on a surface of a haptic rocker button of the mobile device.

9. The computer readable storage media of claim 8, the operation of presenting the Braille content on a surface of the haptic rocker button of the mobile device further comprising:
generating a Braille-patterned haptic-tactile feedback on the surface of the haptic rocker button, the Braille content being the Braille-patterned haptic-tactile feedback.

10. The computer readable storage media of claim 8, the operations further comprising:
receiving a signal from a sensor; and
determining a speed of a horizontal movement; and
scrolling the Braille content on the haptic rocker button at the determined speed.

11. The computer readable storage media of claim 10, the operations further comprising:
receiving another signal from the sensor; and
determining another speed of the horizontal movement.

12. The computer readable storage media of claim 11, the operations further comprising:
comparing the speed of the horizontal movement with the other speed of the horizontal movement.

13. The computer readable storage media of claim 12, the operations further comprising:
scrolling the Braille content at the other speed.

14. A mobile device comprising:
a haptic rocker button; and
a memory unit configured to store text data;
a converter unit to convert a portion of the text data into a Braille content;
a controller configured to present the Braille content on a surface of the haptic rocker button.

15. The mobile device of claim 14, the device further comprising:
a sensor connected to the haptic rocker button and to the controller, the sensor configured to sense an input from the haptic rocker button.

16. The device of claim 15, the controller having a receiving unit to receive a signal from the sensor, wherein the signal includes a value.

17. The device of claim 16, the controller including an analyzer unit to determine a speed of a horizontal movement according to the value, wherein the controller is further configured to scroll the Braille content at the speed.

18. The device of claim 17, wherein the receiving unit is further configured to receive another signal from the sensor, and wherein the analyzer unit is further configured to determine another speed according to another value included in the other signal, and wherein the controller is further configured to scroll the Braille content on the haptic rocker button at the other speed.

19. The device of claim 14, further comprising:
a non-haptic input device; and
a sensor connected to the non-haptic input device and to the controller.

20. The device of claim 19, further comprising:
a receiving unit configured to receive a signal from the sensor, wherein the controller is further configured to vertically scroll through the Braille content according to the signal.
